(19) United States
(12) Patent Application Publication
(10) Pub. No.: US 2005/0114227 A1
(43) Pub. Date: May 26, 2005

(54) Web-based tool for maximizing value from surplus assets

(76) Inventors: Craig M. Carter, Chandler, AZ (US); Derek A. Chilcote-Bacco, Beaverton, OR (US)

Correspondence Address: Blakely, Sokoloff, Taylor & Zafman LLP, Suite 101, 5285 S.W. Meadows Road, Lake Oswego, OR, 97035, US

(21) Appl. No.: 10/722,846

(22) Filed: Nov. 25, 2003

(51) Int. Cl. G06F 17/60

(52) U.S. Cl. 705/26; 705/28

(57) ABSTRACT

A method for maximizing value from surplus assets. Users may submit surplus items into an active list. The financial value and condition of the submitted surplus item is assessed. The disposition path for the surplus item is determined. The surplus item may be used internally for enabling other employees to request reuse of the item or used externally by scrapping, donating, or reselling the item.

### BACKGROUND OF THE INVENTION

1. Field of the Invention

The present invention is generally related to managing surplus assets. More particularly, the present invention is related to an automated web based process for maximizing value from surplus assets.

2. Description

Many companies manage surplus assets manually using spreadsheets and databases. Often times email is used to track surplus assets in a non-organized manner. For a small company, keeping track of surplus assets manually using spreadsheets and databases may be manageable, but for mid-size and large companies, this method is almost impossible. Other problems associated with manually managing surplus assets include the lack of communication between the employees of the distribution centers that actually house the surplus assets in bulk and the business groups within the company that have or could use the surplus assets. Typically, instead of routing the surplus assets to other employees within the company for reuse, the surplus assets are sold as used assets outside of the company.

Thus, what is needed is a system and method for reusing surplus assets within a company. What is further needed is a system and method that maximizes the value of surplus assets within the company.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a block diagram illustrating an exemplary computer system in which certain aspects of the invention may be implemented.

FIG. 2A is a flow diagram illustrating an exemplary method for efficiently maximizing value from surplus assets according to an embodiment of the present invention.

FIG. 2B is a flow diagram illustrating an exemplary method for retrieving surplus assets for reuse within a company according to an embodiment of the present invention.

FIG. 2C is a flow diagram illustrating an exemplary method for enabling reuse of a surplus asset within a company according to an embodiment of the present invention.

### DETAILED DESCRIPTION OF THE INVENTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a Web-based tool for maximizing value from surplus assets by efficiently routing them for internal reuse, or externally for resale, donations or scrapping. A user may input surplus items into the web-based tool. An entity of the company, such as, for example, Corporate Investment Recovery (CIR), may then decide if the surplus item should be reused within the company, scrapped, or externally resold or donated. If the surplus item is to be reused, then the item is posted in a web catalog for other users to request the item. Users of the system may also request items that are not presently available. These desired items are posted on a waitlist. When the item, or one similar to it, becomes available for reuse, the requestor is notified via automatic email. Tasks are given to certain individuals to complete the order of the requested item for reuse. The tasks may include, but are not limited to, obtaining manager approval, shipping the item to be reused, and acknowledging receipt of the reused item. When an employee logs onto the Web tool, if there are any actions that should be taken by that person related to an asset, the actions to be taken are listed in the person's task list.

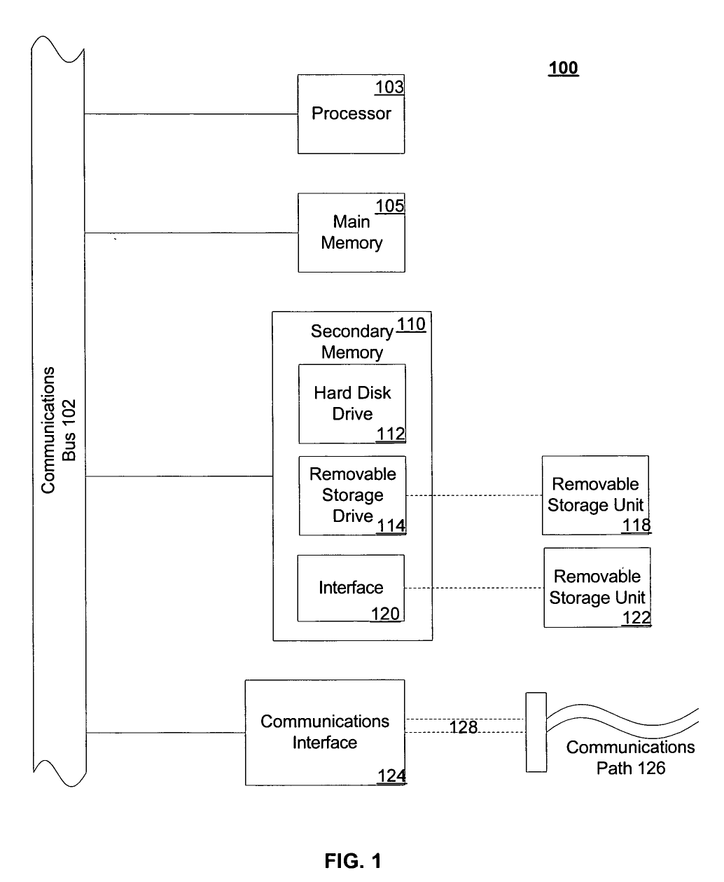

Embodiments of the present invention may be implemented using hardware, software, or a combination thereof and may be implemented in one or more computer systems or other processing systems. In fact, in one embodiment, the invention is directed toward one or more computer systems capable of carrying out the functionality described here. An example implementation of a computer system 100 is shown in FIG. 1. Various embodiments are described in terms of this exemplary computer system 100. After reading this description, it will be apparent to a person skilled in the relevant art how to implement the invention using other computer systems and/or computer architectures.

Computer system 100 includes one or more processors, such as processor 103. Processor 103 is connected to a communication bus 102. Computer system 100 also includes a main memory 105, preferably random access memory (RAM) or a derivative thereof (such as SRAM, DRAM, etc.), and may also include a secondary memory 110. Secondary memory 110 may include, for example, a hard disk drive 112 and/or a removable storage drive 114, representing a floppy disk drive, a magnetic tape drive, an optical disk drive, etc. Removable storage drive 114 reads from and/or writes to a removable storage unit 118 in a well-known manner. Removable storage unit 118 represents a floppy disk, magnetic tape, optical disk, etc., which is read by and written to by removable storage drive 114. As will be appreciated, removable storage unit 118 includes a computer usable storage medium having stored therein computer software and/or data.

In alternative embodiments, secondary memory 110 may include other similar means for allowing computer programs or other instructions to be loaded into computer system 100. Such means may include, for example, a removable storage unit 122 and an interface 120. Examples of such may include a program cartridge and cartridge interface (such as that found in video game devices), a removable memory chip (such as an EPROM (erasable programmable read-only memory), PROM (programmable read-only memory), or FLASH memory) and associated socket, and other removable storage units 122 and interfaces 120 which allow software and data to be transferred from removable storage unit 122 to computer system 100.

Computer system 100 may also include a communications interface 124. Communications interface 124 allows software and data to be transferred between computer system 100 and external devices. Examples of communications interface 124 may include a modem, a network interface (such as an Ethernet card), a communications port, a PCMCIA (personal computer memory card international association) slot and card, a wireless LAN (local area network) interface, etc. Software and data transferred via communications interface 124 are in the form of signals 128 which may be electronic, electromagnetic, optical or other signals capable of being received by communications interface 124. These signals 128 are provided to communications interface 124 via a communications path (i.e., channel) 126. Channel 126 carries signals 128 and may be implemented using wire or cable, fiber optics, a phone line, a cellular phone link, a wireless link, and other communications channels.

In this document, the term “computer program product” refers to removable storage units 118, 122, and signals 128. These computer program products are means for providing software to computer system 100. Embodiments of the invention are directed to such computer program products.

Computer programs (also called computer control logic) are stored in main memory 105, and/or secondary memory 110 and/or in computer program products. Computer programs may also be received via communications interface 124. Such computer programs, when executed, enable computer system 100 to perform the features of the present invention as discussed herein. In particular, the computer programs, when executed, enable processor 103 to perform the features of embodiments of the present invention. Accordingly, such computer programs represent controllers of computer system 100.

In an embodiment where the invention is implemented using software, the software may be stored in a computer program product and loaded into computer system 100 using removable storage drive 114, hard drive 112 or communications interface 124. The control logic (software), when executed by processor 103, causes processor 103 to perform the functions of the invention as described herein.

In another embodiment, the invention is implemented primarily in hardware using, for example, hardware components such as application specific integrated circuits (ASICs). Implementation of hardware state machine(s) so as to perform the functions described herein will be apparent to persons skilled in the relevant art(s). In yet another embodiment, the invention is implemented using a combination of both hardware and software.

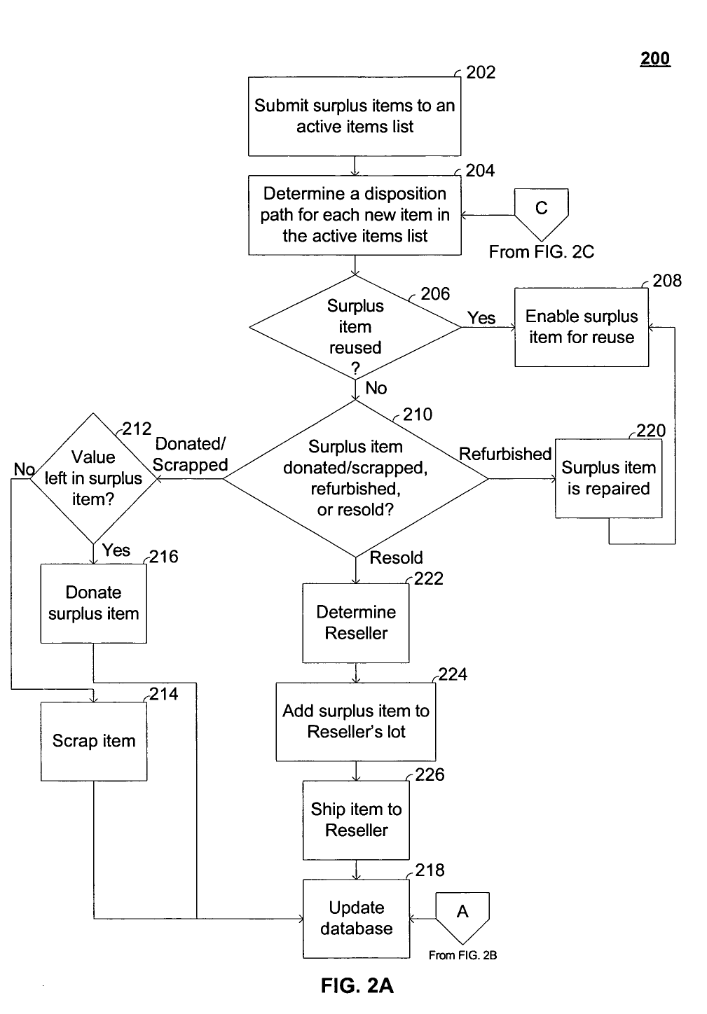

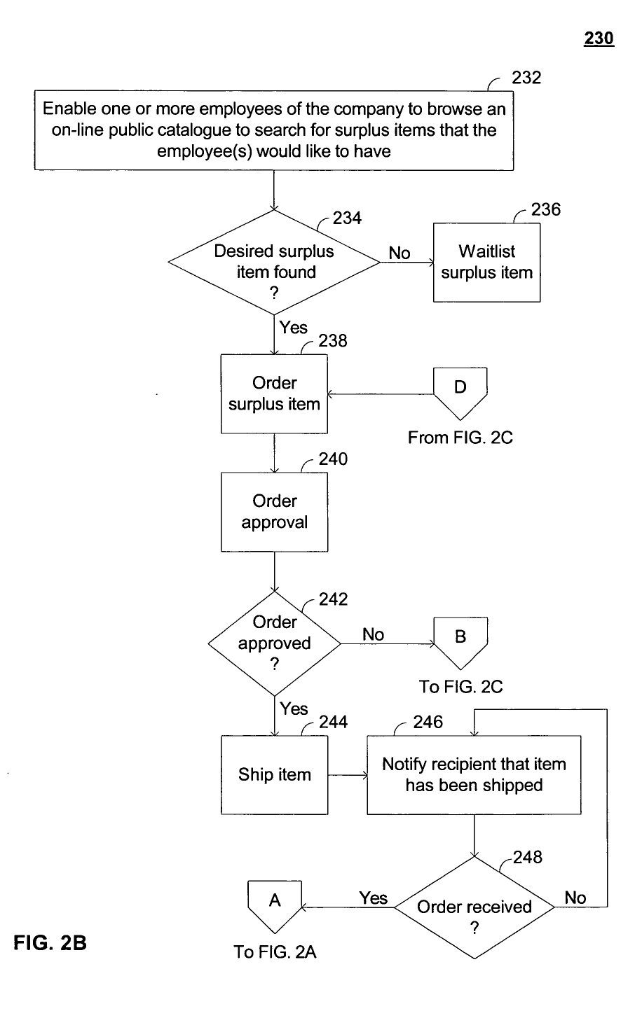

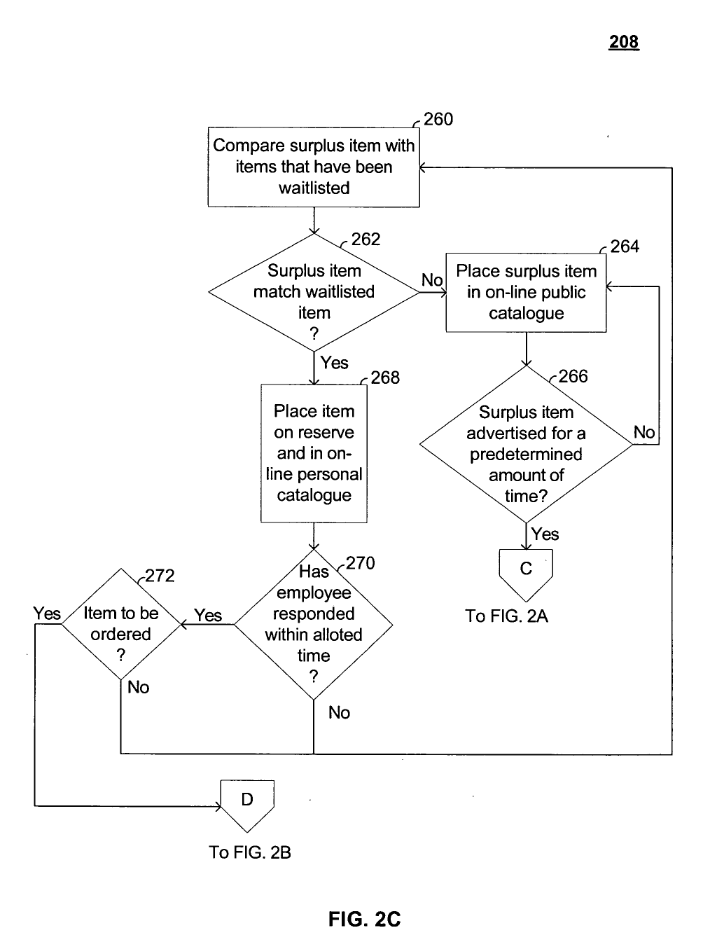

FIG. 2A is a flow diagram 200 illustrating a method for maximizing value from surplus assets efficiently according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention.

The process begins at block 202, where one or more surplus items are submitted to an active items list on a Web-based tool. In one embodiment, a direct user may submit the one or more surplus items that the direct user is no longer in need of to the active items list on the Web tool. In another embodiment, the direct user may not want to manage the surplus item until the item is requested for reuse, and therefore, may request a surplus pickup of the item from a distribution center. In turn, the distribution center may enter the one or more surplus items that were received from the direct user into the active items list. The distribution center will then manage the surplus item throughout the remaining process.

In one embodiment, the person submitting the surplus item (i.e., the direct user or a person from the distribution center) may be provided a questionnaire to provide the tool with certain properties about the item being submitted. For example, if the surplus item is a hard drive, the tool will request properties of the hard drive and whether or not the hard drive has been cleared. Thus, the questionnaires may be customized by an administrator of the tool, based on the type of asset the person is submitting. In this embodiment, the questions may then be presented to the person dynamically, based on the type of asset being submitted.

Users of the Web tool, such as a direct user or a person from the distribution center, may enter the tool using a secure password. In one embodiment, users may use their company login identification to enter the tool. Site security may include, but is not limited to, the NT Authentication option. The NT Authentication option allows a user to use Windows NT user names, passwords, and domains to control the security logins of the Web interface. One skilled in the relevant art(s) will know that other security options may also be used.

The surplus items may include, but are not limited to, electronic equipment, office furniture, etc. Electronic equipment may include, but is not limited to, servers, workstations, laptops, monitors, printers, keyboards, copiers, audio/visual equipment, etc. Furniture may include, but is not limited to, desks, chairs, computer stands, lamps, tables, etc.

In block 204, a disposition path for each new surplus item submitted in the active items list is determined. For example, in one embodiment, an entity of the company may determine whether the surplus item is to be donated or scrapped, refurbished, resold, or reused by someone within the company. An entity of the company delegated to handle this may include, but is not limited to, Corporate Investment Recovery (CIR) or some other business organization within the company that has the power to determine the disposition of the surplus items.

To determine the disposition path for the surplus items, each surplus item is reviewed by a member of CIR (or some other organization or group within the company) identifying the surplus item by serial number or an asset tag number provided by the company. Research is performed to determine product information, depreciation information, original cost information, and other asset information about the item that may aid the researcher in determining the disposition path for the item. The reviewer of the surplus item may utilize financial data aggregated by the company that relates to the surplus item, such as, for example, SAP data.

Model lookup data containing suggested fees and costs may also be used to determine the value of the surplus item and the amount of savings that might be generated by the reuse of the surplus item. In one embodiment, if specific data about the surplus item is not provided in the company data (i.e., SAP data), the model lookup data may be used as a replacement for the missing information within the company data. For example, if a direct user within the company submitted an IBM (International Business Machines) laptop, model number 600e, the reviewer may obtain the standard amount of expected cost and savings related to that item from the model lookup table. The reviewer may also obtain asset information from an asset center database, which may often times provide a more realistic tracking of depreciation for surplus items.

Once all of the depreciation and original cost information has been determined, the amount of savings in reusing the item is determined. Note that at any time during this process, the reviewer has the ability to modify the data, if needed, to obtain a more realistic savings amount for the surplus item. After reviewing the amount of savings, the reviewer will determine the disposition path for the surplus item accordingly.

In decision block 206, it is determined whether the surplus item is to be reused within the company. For a surplus item to be reused within the company, the surplus item may be assessed as being able to net the company a savings. If it is determined that the surplus item is to be reused within the company, the process proceeds to block 208. In block 208, the item is enabled for reuse within the company. The reuse process is described below with reference to FIG. 2C.

Returning to decision block 206, if it is determined that the surplus item is not to be reused within the company, the process proceeds to decision block 210. In decision block 210, it is determined whether the surplus item is to be scrapped/donated, refurbished, or resold. If the surplus item is to be scrapped/donated, the process proceeds to decision block 212.

For a surplus item to be scrapped/donated, the surplus item may be assessed as having no benefit to the company in reusing the surplus item within the company. In decision block 212, it is determined whether there is any value left in the surplus item that has been assessed as having no benefit to the company. If there is no value left in the surplus item, the process proceeds to block 214, where the surplus item is scrapped (i.e., thrown away). A database indicating the actual disposition of the surplus item along with other important information regarding the item is then updated in block 218.

Returning to decision block 212, if it is determined that there is some value left in the surplus item, the process proceeds to block 216. In block 216, the surplus item is donated to an organization, such as, but not limited to, a charitable organization. The process then proceeds to block 218, where the database indicating the actual disposition of the surplus item along with other important information regarding the item, such as the savings to the company by donating the item, is updated.

When a surplus item has value, but just needs repairing, the item may be refurbished for reuse within the company. Returning to decision block 210, if it is determined that the surplus item is to be refurbished, the process proceeds to block 220. In block 220, the item is repaired. In one embodiment, the distribution center may manage the repair of the item. In another embodiment, another entity in the company may handle the repair of the item. Once the item is repaired, the item is enabled for reuse in block 208, which is described below with reference to FIG. 2C.

When a surplus item is determined to have no use within the company, but has enough value where the company can actually recoup some money from it by selling it outside of the company, the item may be resold outside of the company. Returning to decision block 210, if it is determined that the item is to be resold, the process then proceeds to block 222.

In block 222, a reseller is determined. In one embodiment, the resellers are company employees. In another embodiment, the resellers may work outside of the company or may be company employees. In yet another embodiment, the resellers may work for other companies, such as, for example, contractors or independent contractors. Based on the type of surplus item and the expertise of the reseller, the item is added to a lot for the particular reseller (block 224). The surplus item is then shipped to the reseller in block 226. The disposition of the surplus item along with any other important data, such as, but not limited to, the savings incurred by the company in reselling the item, is then updated in the database in block 218.

FIG. 2B is a flow diagram 230 illustrating an exemplary method for retrieving surplus assets for reuse within a company according to an embodiment of the present invention. The invention is not limited to the embodiment described herein with respect to flow diagram 230. Rather, it will be apparent to persons skilled in the relevant art(s) after reading the teachings provided herein that other functional flow diagrams are within the scope of the invention.

The process begins with block 232, where employees of the company may browse an on-line public catalogue of surplus items on the tool to look for surplus items that the employee would like to have. The employee may enter the tool in a similar manner as described above with regards to users submitting surplus items (see block 202 in FIG. 2A). The process then proceeds to decision block 234.

In decision block 234, if the desired item is not found in the on-line public catalogue, the process proceeds to block 236. In block 236, the employee may waitlist the desired surplus item. To waitlist the item, the employee will provide a description of the desired item, such as, for example, a model number of the item. Employees that request surplus items that are waitlisted have priority over other employees within the company when the item becomes available.

Returning to decision block 234, if the desired item is found in the on-line public catalogue, the process proceeds to block 238. In block 238, the employee may order the item. The tool does not limit the employee to one item. In one embodiment, the employee may order a plurality of items. Each of the items may have different owners as well. Items are ordered by placing the items in a shopping cart in a well know manner. When an item is ordered, the tool may request that the employee provide information regarding where or how the item may be used. For example, if the surplus item is a server, the tool may request that the employee indicate where the server will be used. As previously indicated, an administrator may customize the questions, thereby enabling the questions to be presented dynamically to the employee based on the type of asset being ordered. The process then proceeds to block 240.

In block 240, an email is sent to an appropriate person within the company, such as, for example, the employee's manager, for approval of the order. In one embodiment, depending on the cost of the items, more than one level of approval may be needed. For example, items with a price tag of $2,000.00 or more may need approval from a financial analyst in the employee's department as well as the employee's manager.

In decision block 242, it is determined whether the order was approved. If the order was approved, the process proceeds to block 244.

In block 244, an email is sent to either the direct user managing the asset or the distribution center that submitted the surplus item(s). The email informs them that someone has ordered the item(s) and that the order has been approved. The email also provides the direct user or distribution center with the task of shipping the item(s) to the designated employee and providing an indication by email that the item(s) has been shipped. Once the item(s) has been shipped, the process then proceeds to block 246.

In block 246, the recipient of the ordered items (i.e., the employee that ordered the surplus items for reuse) is notified that the item(s) has been shipped. The recipient is also tasked to send an email indicating when the item(s) is received.

In decision block 248, it is determined whether the order was received. If an email has been received indicating that the item(s) was received, the process proceeds to block 218 in FIG. 2A, where databases, such as the SAP database and the asset center database, are updated to indicate that the item for reuse has been received along with any other important information, such as, but not limited to, savings incurred by the company in reusing the item within the company, moving the depreciation for the item to the acquiring department, etc. The information in the databases may also be used to generate reports. The reports may include, but are not limited to, such things as the original cost of the surplus item, actual reuse value of the surplus item, etc.

In one embodiment, when the email indicating that the order was received by the recipient arrives, rewards may be given as an incentive to reinforce the importance of submitting unused surplus items to enable other employees within the company to reuse the surplus items. For example, credits may be given to users that submit a surplus item that gets reused within the company. The credits may be used to reduce a handling/transaction fee charged to all requestors of items from the web catalogue. Also, appreciation emails may automatically be generated to thank the employee who submitted the surplus item and to thank the requestor who ordered the surplus item. The appreciation emails may include the amount of money that the submitter and requestor saved the company by reusing the surplus item.

Returning to decision block 248, if the email indicating that the item(s) has been received is not received by the tool, then the process proceeds back to block 246 where another email is sent to the recipient of the ordered items after a predetermined period of time as a reminder to the recipient to notify the tool upon receipt of the ordered item(s).

Returning to decision block 242, if the ordered item(s) is not approved, the item is re-enabled for reuse as if it were a new surplus item. This process is described below with reference to FIG. 2C.

FIG. 2C is a flow diagram 208 illustrating an exemplary method for enabling reuse of a surplus asset within a company according to an embodiment of the present invention. The invention is not limited to the embodiment described herein with respect to flow diagram 208. Rather, it will be apparent to persons skilled in the relevant art(s) after reading the teachings provided herein that other functional flow diagrams are within the scope of the invention.

The process begins with block 260, where the new surplus item for reuse is compared with items that have been waitlisted. A description of the new surplus item is compared with a description of each waitlisted item until either a match is found or no waitlisted item matches the description of the new surplus item. The process then proceeds to decision block 262.

In decision block 262, it is determined whether the new surplus item matched a waitlisted item. If the new surplus item did not match a waitlisted item, the process proceeds to block 264, where the item is placed in an on-line public catalogue of surplus items available for reuse. The process then proceeds to decision block 266.

In decision block 266, it is determined whether the new surplus item has been advertised in the on-line public catalogue for a predetermined amount of days. For example, in one embodiment, a predetermined amount of days may be 60 days. Yet in another embodiment, a predetermined amount of days to be advertised in the public on-line catalogue without being selected by an employee may be 90 days. If the surplus item has been advertised for less than the predetermined amount of days, the surplus item will continue to be advertised in the public on-line catalogue at block 264.

Returning to decision block 266, if it is determined that the surplus item has been advertised on the on-line public catalogue for at least the predetermined amount of days, then the process returns to block 204 in FIG. 2A to be re-evaluated and/or re-dispositioned.

Returning to decision block 262, if the new surplus item matches the description of a waitlisted item, the process proceeds to block 268. In block 268, the new surplus item is placed in an on-line personal catalogue and put on reserve for the employee who waitlisted the item. The employee who waitlisted the item is notified via email that the item is now available. The employee is given a predetermined amount of time to decide whether or not the item meets the needs of the employee and whether the employee wants to order the item. The employee is tasked to send a reply email indicating whether or not they want to place an order for the surplus item The process then proceeds to decision block 270.

In decision block 270, if the employee has not responded within the predetermined amount of time, the process proceeds back to block 260, where the surplus item is compared with items that are waitlisted. If, in decision block 270, the predetermined amount of time has not elapsed, the surplus item will remain in waitlist reserve. If the employee has responded, the process proceeds to decision block 272.

In decision block 272, if the employee still desires the item(s), the process proceeds to block 238 in FIG. 2B to enable the employee to order the item. If the employee decides not to order the item, the process proceeds back to block 260, where the surplus item is compared with items that are waitlisted.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1. A Web-based tool for managing used assets comprising:
enabling submission of a surplus item into an active items list, wherein the surplus item is no longer being used by a direct user;
assessing the financial value and condition of the surplus item; and
enabling a company to determine a disposition path for the surplus item based on the assessment of the surplus item.

2. The method of claim 1, wherein the disposition path for the surplus item comprises scrapping the surplus item when there is no value left in the surplus item.

3. The method of claim 1, wherein the disposition path for the surplus item comprises donating the surplus item when the surplus item has value yet is no longer beneficial to the company.

4. The method of claim 1, wherein the disposition path for the surplus item comprises reselling the surplus item when the resell value of the surplus item outweighs the benefit of the company keeping the surplus item.

5. The method of claim 1, wherein the disposition path for the surplus item comprises refurbishing the surplus item for reuse of the surplus item within the company.

6. The method of claim 1, wherein the disposition path for the surplus item comprises enabling the reuse of the surplus item within the company when the surplus item provides value for the company.

7. The method of claim 1, wherein assessing the financial value and condition of the surplus item comprises reviewing product information, depreciation information, and asset information about the surplus item.

8. The method of claim 1, wherein the disposition path for the surplus item comprises reselling the surplus item, wherein reselling the surplus item comprises:
determining a reseller;
adding the surplus item to a lot for the reseller; and
shipping the surplus item to the reseller.

9. The method of claim 1, further comprising updating one or more databases based on results for the disposition path chosen for the surplus item.

10. The method of claim 1, wherein the disposition path for the surplus item comprises enabling the surplus item to be reused within the company, wherein enabling the surplus item to be reused comprises:
comparing a description of the surplus item with items that have been waitlisted;
if a match is found,
placing the surplus item on reserve in an on-line personal catalogue;
notifying the person who waitlisted the item that the surplus item has been put on reserve; and
enabling the person to order the item within a first predetermined time period; and
if the match is not found,
placing the surplus item in an on-line public catalogue to allow an employee to purchase surplus items from the catalogue, wherein the surplus item will remain in the catalogue within a second predetermined time period.

11. The method of claim 10, wherein if the surplus item remains in the catalogue within the second predetermined time period without being ordered by an employee, the method further comprises removing the surplus item from the on-line public catalogue for re-evaluation.

12. The method of claim 10, wherein enabling the person to order the item within a first predetermined time period comprises removing the surplus item from reserve if the person does not order the surplus item.

13. The method of claim 1, further comprising:
enabling one or more employees to browse an on-line public catalogue to search for wanted surplus items;
if the wanted surplus item is found,
ordering the surplus item;
awaiting approval of the ordered surplus item;
if the ordered surplus item is approved,
enabling the surplus item to be shipped to the employee;
notifying the employee that the surplus item has been shipped;
awaiting a response from the employee that the surplus item has been received; and
updating one or more databases with information regarding the surplus item upon receipt of the response.

14. The method of claim 13, further comprising providing incentive credits to employees for submitting surplus items that are reused within the company.

15. The method of claim 14, further comprising sending appreciation emails to employees for submitting surplus items that are reused within the company.

16. The method of claim 1, further comprising:
enabling one or more employees to browse an on-line public catalogue to search for wanted surplus items;
if the wanted surplus item is not found, then waitlisting the surplus item, wherein the employee who waitlisted the surplus item is given priority over the waitlisted item.

17. An article comprising: a storage medium having a plurality of machine accessible instructions, wherein when the instructions are executed by a processor, the instructions provide for enabling submission of a surplus item into an active items list, wherein the surplus item is no longer being used by a direct user;
assessing the financial value and condition of the surplus item; and
enabling a company to determine a disposition path for the surplus item based on the assessment of the surplus item.

18. The article of claim 17, wherein the disposition path for the surplus item comprises instructions for scrapping the surplus item when there is no value left in the surplus item.

19. The article of claim 17, wherein the disposition path for the surplus item comprises instructions for donating the surplus item when the surplus item has value yet is no longer beneficial to the company.

20. The article of claim 17, wherein the disposition path for the surplus item comprises instructions for reselling the surplus item when the resell value of the surplus item outweighs the benefit of the company keeping the surplus item.

21. The article of claim 17, wherein the disposition path for the surplus item comprises instructions for refurbishing the surplus item for reuse of the surplus item within the company.

22. The article of claim 17, wherein the disposition path for the surplus item comprises instructions for enabling the reuse of the surplus item within the company when the surplus item provides value for the company.

23. The article of claim 17, wherein instructions for assessing the financial value and condition of the surplus item comprises instructions for reviewing product information, depreciation information, and asset information about the surplus item.

24. The article of claim 17, wherein the disposition path for the surplus item comprises instructions for reselling the surplus item, wherein the instructions for reselling the surplus item comprise:
determining a reseller;
adding the surplus item to a lot for the reseller; and
shipping the surplus item to the reseller.

25. The article of claim 17, further comprising instructions for updating one or more databases based on results for the disposition path chosen for the surplus item.

26. The article of claim 17, wherein the disposition path for the surplus item comprises instructions for enabling the surplus item to be reused within the company, wherein the instructions for enabling the surplus item to be reused comprise:
comparing a description of the surplus item with items that have been waitlisted;
if a match is found,
placing the surplus item on reserve in an on-line personal catalogue;
notifying the person who waitlisted the item that the surplus item has been put on reserve; and
enabling the person to order the item within a first predetermined time period; and
if the match is not found,
placing the surplus item in an on-line public catalogue to allow an employee to purchase surplus items from the catalogue, wherein the surplus item will remain in the catalogue within a second predetermined time period.

27. The article of claim 26, wherein if the surplus item remains in the catalogue within the second predetermined time period without being ordered by an employee, the instructions further comprise instructions for removing the surplus item from the on-line public catalogue for re-evaluation.

28. The article of claim 26, wherein instructions for enabling the person to order the item within a first predetermined time period comprises instructions for removing the surplus item from reserve if the person does not order the surplus item.

29. The article of claim 17, further comprising instructions for:
enabling one or more employees to browse an on-line public catalogue to search for wanted surplus items;
if the wanted surplus item is found,
ordering the surplus item;
awaiting approval of the ordered surplus item;
if the ordered surplus item is approved,
enabling the surplus item to be shipped to the employee;
notifying the employee that the surplus item has been shipped;
awaiting a response from the employee that the surplus item has been received; and
updating one or more databases with information regarding the surplus item upon receipt of the response.

30. The article of claim 29, further comprising instructions for providing incentive credits to employees for submitting surplus items that are reused within the company.

31. The article of claim 29, further comprising instructions for sending appreciation emails to employees for submitting surplus items that are reused within the company.

32. The article of claim 17, further comprising instructions for:
enabling one or more employees to browse an on-line public catalogue to search for wanted surplus items;
if the wanted surplus item is not found, then waitlisting the surplus item, wherein the employee who waitlisted the surplus item is given priority over the waitlisted item.
